(19) United States
(12) Patent Application Publication
(10) Pub. No.: US 2010/0093320 A1
(43) Pub. Date: Apr. 15, 2010

(54) METHODS AND SYSTEMS FOR PROVIDING A NAME-BASED COMMUNICATION SERVICE

(75) Inventors: Sooyong Ha, Montreal (CA); Brian Patrick Cockerton, Montreal (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: FIRSTIN WIRELESS TECHNOLOGY INC, MONTREAL, CA (US)

(21) Appl. No.: 12/444,664

(22) PCT Filed: Oct. 10, 2007
(86) PCT No.: PCT/CA07/01801

§ 371 Date: Apr. 7, 2009

Related U.S. Application Data
(60) Provisional application No. 60/829,109, filed on Oct. 11, 2006.

(51) Int. Cl. H04W 4/00; H04M 3/42; G06F 15/16

(52) U.S. Cl. 455/414.1; 379/216.01; 455/466; 709/206

(57) ABSTRACT

Methods and systems for providing a name-based communication service. A system may comprise an input for receiving from a first communication device a name registered in connection with the communication service and provided by a user of the first communication device. The system may also comprise a processing entity for: identifying a profile associated with the name and configured by a party having registered the name; determining, based on the profile, at least one action to perform from among a plurality of actions performable by said system, the plurality of actions including: (i) transmitting to the first communication device information regarding the party and included in the profile; and (ii) attempting to establish a phone call between the first communication device and a second communication device associated with the party; and performing the at least one action.

### CROSS-REFERENCE TO RELATED APPLICATION

This application claims priority from U.S. Provisional Patent Application No. 60/829,109 filed on Oct. 11, 2006 and hereby incorporated by reference herein.

### FIELD OF THE INVENTION

The present invention relates generally to communications and, more particularly, to methods and systems for providing a communication service based on names registered in connection with the communication service.

### BACKGROUND

Communication devices allow users to conveniently and efficiently communicate with one another or obtain various types of information. In particular, wireless communication devices such as cellular phones or other mobile communication devices allow users to effect telephonic and possibly other communications while retaining their mobility.

Although communication devices certainly facilitate communications, it is typically necessary for users to know, remember and/or keep a record of various types of contact information (e.g., telephone numbers, email addresses, etc.) in order to contact individuals or organizations. This may be difficult, inconvenient and/or impractical for some users. In particular, such difficulty, inconvenience and/or impracticality may be encountered when using a wireless communication device that has limited information storage and information access capabilities.

For these and other reasons, there remains a need to improve the convenience and efficiency with which users of communication devices can effect communications.

### SUMMARY OF THE INVENTION

As embodied and broadly described herein, the present invention provides a method for execution by a communication system. The method comprises: receiving from a first communication device a name registered in connection with a communication service and provided by a user of the first communication device; identifying a profile associated with the name and configured by a party having registered the name; determining, based on the profile, at least one action to perform from among a plurality of actions performable by the communication system, the plurality of actions including: (i) transmitting to the first communication device information regarding the party and included in the profile; and (ii) attempting to establish a phone call between the first communication device and a second communication device associated with the party; and performing the at least one action.

The present invention also provides a system for providing a communication service. The system comprises an input for receiving from a first communication device a name registered in connection with the communication service and provided by a user of the first communication device. The system also comprises a processing entity for: identifying a profile associated with the name and configured by a party having registered the name; determining, based on the profile, at least one action to perform from among a plurality of actions performable by the system, the plurality of actions including: (i) transmitting to the first communication device information regarding the party and included in the profile; and (ii) attempting to establish a phone call between the first communication device and a second communication device associated with the party; and performing the at least one action.

The present invention also provides a method for execution by a communication system. The method comprises: receiving a text message from a wireless communication device, the text message conveying a name registered in connection with a communication service and provided by a user of the wireless communication device; identifying a profile associated with the name and configured by a party having registered the name; determining, based on the profile, at least one action to perform from among a plurality of actions performable by the communication system, the plurality of actions including: (i) transmitting at least one message to the wireless communication device, the at least one message conveying information regarding the party and included in the profile; and (ii) transmitting at least one telephony message to attempt establishing a phone call between the wireless communication device and a given communication device associated with the party; and performing the at least one action.

The present invention also provides a system for providing a communication service. The system comprises an input for receiving a text message from a wireless communication device, the text message conveying a name registered in connection with the communication service and provided by a user of the wireless communication device. The system also comprises a processing entity for: identifying a profile associated with the name and configured by a party having registered the name; determining, based on the profile, at least one action to perform from among a plurality of actions performable by the system, the plurality of actions including: (i) transmitting at least one message to the wireless communication device, the at least one message conveying information regarding the party and included in the profile; and (ii) transmitting at least one telephony message to attempt establishing a phone call between the wireless communication device and a given communication device associated with the party; and performing the at least one action.

The present invention also comprises a method for execution by a communication system. The method comprises: receiving a message from a first communication device, the message conveying a name registered in connection with a communication service and provided by a user of the first communication device; identifying a profile associated with the name and configured by a party having registered the name; obtaining from the profile information allowing a second communication device associated with the party to be called; and transmitting at least one telephony message to attempt establishing a phone call between the first communication device and the second communication device.

The present invention also provides a system for providing a communication service. The system comprises an input for receiving a message from a first communication device, the message conveying a name registered in connection with the communication service and provided by a user of the first communication device. The system also comprises a processing entity for: identifying a profile associated with the name and configured by a party having registered the name; obtaining from the profile information allowing a second communication device associated with the party to be called; and transmitting at least one telephony message to attempt establishing a phone call between the first communication device and the second communication device.

The present invention also provides a server for facilitating registration of names in connection with a communication service. The server comprises a data network interface for exchanging data with a computing apparatus over a data network. The server also comprises a processing unit for implementing a web site. The web site enables a user of the computing apparatus to register a name in connection with the communication service. The web site enables the user of the computing apparatus to configure a profile associated with the name such that the profile indicates which of a plurality of actions is to be performed in response to a message conveying the name and transmitted by a first communication device, the plurality of actions including: (i) transmitting to the first communication device information included in the profile; and (ii) attempting to establish a phone call between the first communication device and a second communication device.

The present invention also provides a wireless communication device comprising an input device for interacting with a user and a wireless network interface for exchanging messages over a wireless network. The wireless communication device also comprises a processing unit coupled to the input device and the wireless network interface. The processing unit is operative for: receiving a name provided by the user via the input device; generating a text message conveying the name and destined for a communication system, without requiring the user to provide a short code associated with the communication system via the input device; and releasing the text message via the wireless network interface.

These and other aspects of the invention will become apparent to those of ordinary skill in the art upon review of the following description of embodiments of the invention in conjunction with the accompanying drawings.

### BRIEF DESCRIPTION OF THE DRAWINGS

A detailed description of non-limiting embodiments of the present invention is provided herein below, by way of example only, with reference to the accompanying drawings, in which:

FIG. 1 shows a communications network comprising a name-based communication system that provides a name-based communication service in accordance with an embodiment of the present invention;

FIG. 2 shows an example of potential contents of a database of the name-based communication system;

FIG. 3 shows an example of potential contents of another database of the name-based communication system;

FIG. 4 shows an example of interaction between a wireless communication device and the name-based communication system when a user of the wireless communication device causes the wireless communication device to transmit a message conveying a name registered in connection with the name-based communication service;

FIGS. 5A to 5C show examples scenarios illustrating messages exchanged between the name-based communication system and the wireless communication device and/or another communication device in response to the message conveying the name registered in connection with the name-based communication service;

FIG. 6 shows an alternative embodiment in which the user can use a wired phone to interact with the name-based communication system as part of the name-based communication service; and

FIG. 7 shows another alternative embodiment in which the user can use a computing apparatus to interact with the name-based communication system as part of the name-based communication service,

It is to be expressly understood that the description and drawings are only for purposes of illustration of example embodiments of the present invention and are an aid for understanding. They are not intended to be a definition of the limits of the invention.

### DETAILED DESCRIPTION OF EMBODIMENTS

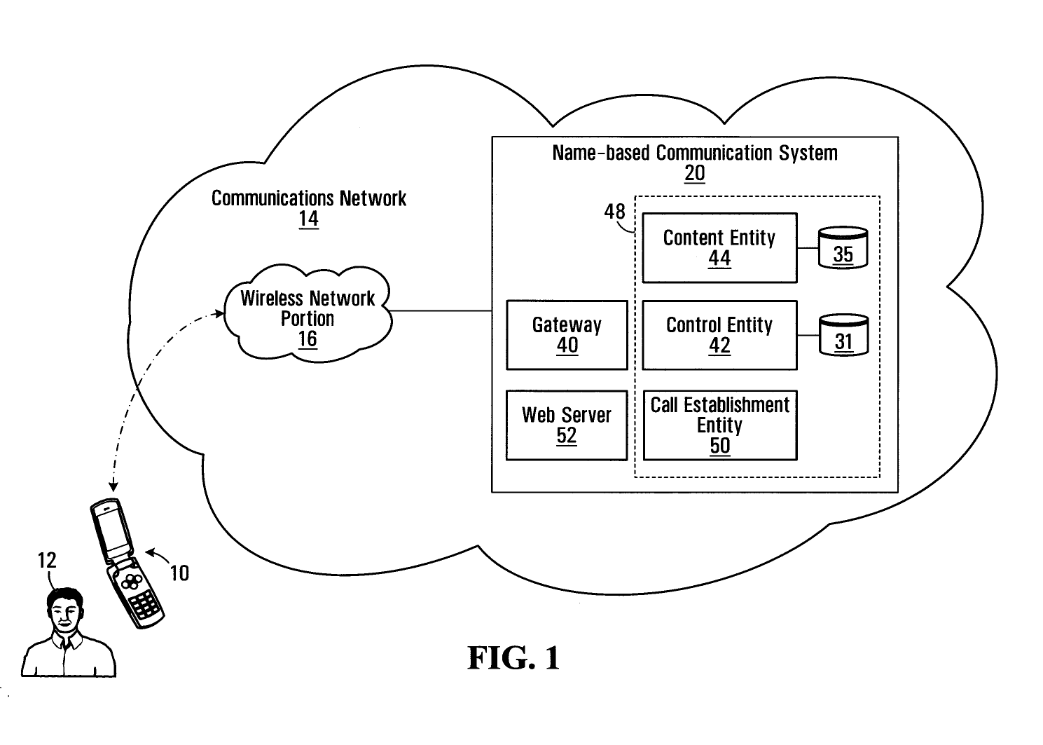

FIG. 1 shows a wireless communication device 10 that can be used by a user 12 to communicate over a communications network 14. The wireless communication device 10 may be a cellular phone or any other mobile communication device, including a telephony-enabled personal digital assistant (e.g., BlackBerry®, Palm®, etc.). The wireless communication device 10 is connected to a wireless network portion 16 of the communications network 14 (e.g., a wireless link in combination with a base station and a wireline link).

Communications that can be effected using the wireless communication device 10 include telephone calls and other types of communications, such as text messages (e.g., Short Message Service (SMS) messages), multimedia messages (e.g., Multimedia Message Service (MMS) messages) and/or electronic mail (email) messages.

In addition to effecting such communications, and in accordance with an embodiment of the present invention, the user 12 can use the wireless communication device 10 to communicate with a name-based communication system 20 that provides a communication service based on names registered in connection with the communication service. This communication service will hereinafter be referred to as a “name-based communication service”.

As further discussed below, the user 12 can use the wireless communication device 10 to provide a particular name registered in connection with the name-based communication service and transmit a message conveying the particular name to the name-based communication system 20 in order to: obtain information (e.g., contact information, content information, etc.) regarding a given party (e.g., an individual or an organization) that registered the particular name; and/or call or otherwise contact the given party. This provides a convenient and easy way for the user 12 to obtain information regarding the given party and/or call or otherwise contact the given party, in particular as it is typically easier for the user 12 to remember the particular name than remember a telephone number or other contact information of the given party.

In some embodiments, interaction between the wireless communication device 10 and the name-based communication system 20 may be effected using standard functionality of the wireless communication device 10. For example, in some cases, the wireless communication device 10 may interact with the name-based communication system 20 using text messages (e.g., SMS messages) and/or multimedia messages (e.g., MMS messages). In other embodiments, the wireless communication device 10 may implement a client application specifically designed to interact with the name-based communication system 20. In such embodiments, the client application may enable the wireless communication device 10 to interact with the name-based communication system 20 using text messages, multimedia messages, and/or other types of messages (e.g., messages formatted according to various protocols such as the wireless application protocol (WAP) or a proprietary messaging protocol).

The name-based communication system 20 comprises suitable hardware, firmware, software and/or control logic for implementing a plurality of functional components, including a gateway 40 and a processing entity 48.

The gateway 40 is an interface that enables communication and interoperability between the name-based communication system 20 and other network elements of the communications network 14. To that end, the gateway 40 implements inputs and outputs for exchanging data (e.g., in the form of messages) with network elements of the communications network 14. The gateway 40 may also be adapted to effect various processing operations to implement its functionality. For example, the gateway 40 may process (e.g., translate) messages received at the name-based communication system 20 and formatted according to various protocols (e.g., short message peer-to-peer protocol (SMPP), hypertext transfer protocol (HTTP), etc.) in order to generate corresponding messages in a particular messaging protocol (e.g., a proprietary protocol) used by the name-based communication system 20, and vice versa for messages transmitted by the name-based communication system 20.

The processing entity 48 is operative to determine whether a particular name conveyed by a message originating from a given communication device (such as the wireless communication device 10) and received at the gateway 40 is a name registered in connection with the name-based communication service and to perform one or more actions based on an outcome of this determination. In particular, and as further discussed later on, when determining that the particular name is a name registered in connection with the name-based communication service, the processing entity 48 may: transmit to the given communication device information regarding a certain party that registered the particular name; establish a phone call between the given communication device and a communication associated with the certain party; and/or enable a user of the given communication device to contact the certain party in another way (e.g., by email or text message).

More specifically, in this embodiment, the processing entity 48 comprises a control entity 42, a content entity 44, and a call establishment entity 50.

The control entity 42 is operative to determine whether a particular name conveyed by a message originating from a given communication device (such as the wireless communication device 10) and received at the gateway 40 is a name registered in connection with the name-based communication service. To that end, in this embodiment, the control entity 42 has access to a database 31.

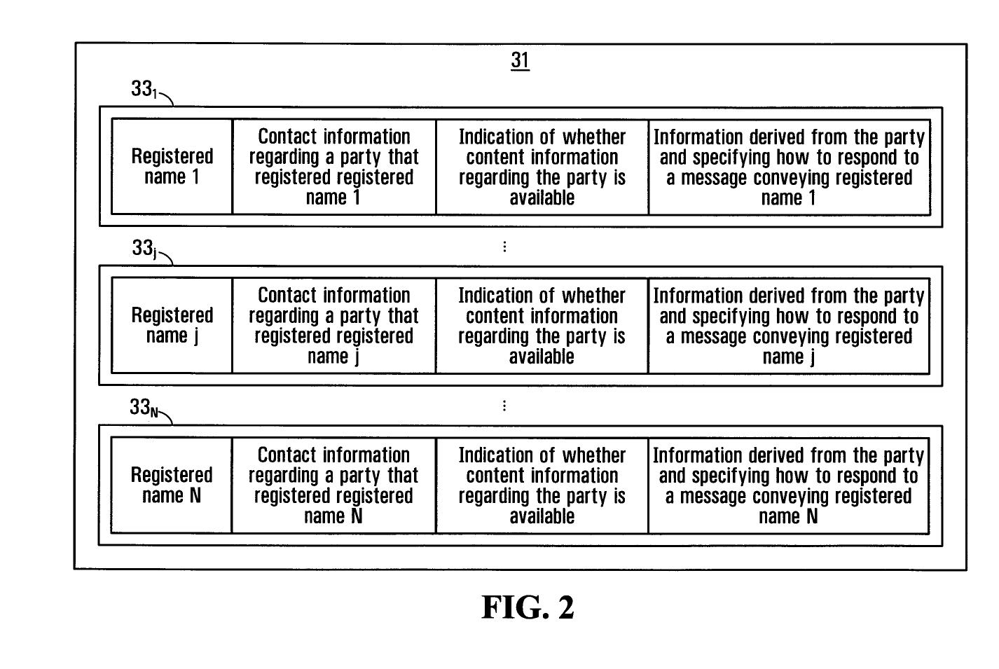

With additional reference to FIG. 2, there is shown an example of potential contents of the database 31. In this example, the database 31 stores a plurality of records 33₁-33_{N}. Each record 33ⱼ (1≦j≦N) is associated with a name registered in connection with the name-based communication service (hereinafter referred to as a “registered name”).

A registered name is a name registered by a party, which may be an individual or an organization (e.g., an enterprise, a government agency, etc.), in connection with the name-based communication service. Examples of registered names for individuals include “Patrick”, “Amanda88”, “paint-guy”, or any other name that an individual may desire to register. Examples of registered names for organizations include “companyXYZ”, “Z-restaurant”, “Club_{—}96”, or any other name that an organization may desire to register.

In this embodiment, the name-based communication service allows a registered name to include a top-level name portion and one or more sub-level name portions that are separated by a delimiter character. For instance, the delimiter character may be an asterisk “*” or any other reserved character according to RFC 3986, while the top-level name portion and each sub-level name portion may be made up of unreserved characters according to RFC 3986. Examples of registered names having a top-level name portion and one or more sub-level name portions include “*companyXYZ”, “sales*companyXYZ”, “canada*sales*companyXYZ”, “*Z-restaurant”, “menu*Z-restaurant”, “*Club_{—}96”, “john*Club_{—}96”, “mary*Club_{—}96”, or any other top-level name portion/sub-level name portion combination that a party may desire to register. This may be particularly useful for a party such as a company that can register various names which can be easily remembered and used by users of communication devices (such as the user 12 of the wireless communication device 10) in order to obtain different information regarding the company and/or call or otherwise contact different individuals or departments within the company.

Each record 33ⱼ includes at least part of a profile configured by the party having registered the registered name in that record. The profile is configured by the party in that it includes information derived from the party, i.e., information provided by the party and/or information derived on a basis of interaction between the party and the name-based communication system 20.

More particularly, in this embodiment, each record 33ⱼ includes contact information regarding the party that registered the registered name in that record. The contact information in each record 33ⱼ may include: one or more telephone numbers (e.g., a home phone number, a cell phone number, a business phone number, etc.); one or more email addresses (e.g., a personal email address, a work email address, a business email address, etc.); one or more instant messaging (IM) identifiers; one or more Uniform Resource Locators (URLs) (e.g., web sites); and/or one or more Internet Protocol (IP) addresses regarding the party that registered the registered name in that record.

In addition, each record 33ⱼ includes an indication of whether the content entity 44 has access to content information regarding the party that registered the registered name in that record. Examples of such content information are provided below.

Furthermore, each record 33ⱼ includes information derived from the party that registered the registered name in that record and specifying how to respond to a message that is received by the name-based communication system 20 and that conveys the registered name in that record. For example, the record 33ⱼ may include information specifying that, when the name-based communication system 20 receives from a given communication device (such as the wireless communication device 10) a message conveying the registered name in that record: part or all of the contact information regarding the party (and included in the record 33ⱼ) and/or part or all of the content information regarding the party (and accessible to the content entity 44) is to be transmitted to the given communication device; a phone call is to be established between the given communication device and a second communication device associated with the party; and/or a user of the given communication device is to be enabled to contact the party in another way (e.g., by email or text message).

The content entity 44 is operative to deliver content information regarding parties that registered some or all of the registered names for which there are records in the database 31. To that end, in this embodiment, the content entity 44 has access to a database 35.

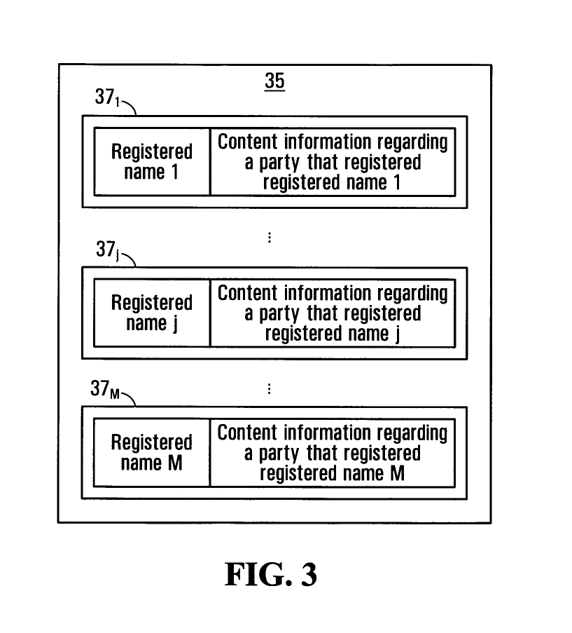

With additional reference to FIG. 3, there is shown an example of potential contents of the database 35. In this example, the database 35 stores a plurality of records 37₁-37_{M}. Each record 37ⱼ (1≦j≦M) is associated with a registered name that corresponds to one of the records 33₁-33_{N} in the database 31 and includes content information regarding the party that registered the registered name.

For example, where the party having registered the registered name associated with the record 37ⱼ is an individual, the content information regarding the individual may include: personal information about the individual (e.g., a real name, an age, an employment, etc.); a multimedia object (e.g., a picture, a video, a song or other sound, etc.) associated with the individual; a message composed or selected by the individual and to be presented to a user of a communication device (such as the user 12 of the wireless communication device 10) that interacts with the name-based communication system 20; and/or any other content information that the individual may desire to present to users of communication devices that interact with the name-based communication system 20.

As another example, where the party having registered the registered name associated with the record 37ⱼ is an organization, the content information regarding the organization may include: an organizational profile of the organization; a directory of telephone numbers associated with the organization (e.g., main number, technical support, sales, etc.); a street address or a list of locations associated with the organization; a map or driving directions to get to the organization; information about one or more products or services offered by the organization (e.g., a list of offered products or services, advertising information, etc.); and/or any other content information that the organization may desire to present to users of communication devices that interact with the name-based communication system 20.

These examples of content information are presented for illustrative purposes only as various other types of content information regarding a party may be deliverable by the content entity 44.

Thus, in the name-based communication service, the profile associated with a given registered name is configured by the party having registered the given registered name. That is, the profile includes information derived from the party (i.e., information provided by the party and/or information derived on a basis of interaction between the party and the name-based communication system 20), namely, in this case, the information included in one of the records 33₁-33_{N} that is associated with the given registered name and, if applicable, the content information included in one of the records 37₁-37_{M} that is associated with the given registered name.

The name-based communication system 20 may provide various ways for a party to register a name and configure a profile associated with that name. For example, in this embodiment, the name-based communication system 20 comprises a web server 52 implementing a web site to enable a party to register a name and configure a profile associated with that name. More particularly, the party may use a computer connected to a data network (e.g., the Internet) to access and interact with the web site implemented by the web server 52 so as to register a name in connection with the name-based communication service and configure a profile associated with the registered name. In configuring the profile, the party may provide via the web site: contact information regarding the party; information specifying how to respond to a message which is received by the name-based communication system 20 and which conveys the registered name; and content information regarding the party, if any. As another example (which is further illustrated later on), when a user of a given communication device (such as the user 12 of the wireless communication device 10) sends to the name-based communication system 20 a message conveying a particular name that is not registered in connection with the name-based communication service, the name-based communication system 20 may send a message back to the given communication device to invite the user to register the particular name. If the user desires to register the particular name, he/she may then use the given communication device to exchange messages with the name-based communication system 20 in order to register the particular name and configure a profile associated with the particular name (alternatively, the user may configure the profile at a later time via the web site implemented by the web server 52).

The call establishment entity 50 is responsive to a command from the control entity 42 to attempt to establish a phone call between a first communication device (such as the wireless communication device 10), which transmitted a message conveying a particular registered name to the name-based communication system 20, and a second communication device associated with a party having registered the particular registered name. For example, based on the profile associated with the particular registered name, the control entity 42 may determine that a phone call is to be established between the first communication device and the second communication device and proceed to cause the call establishment entity 50 to attempt establishing such a phone call. In one case, the call establishment entity 50 may send a first telephony message to the first communication device to establish a first call leg and a second message to the second communication device to establish a second call leg and subsequently connect the first and second call legs to establish a phone call between the first communication device and the second communication device.

Although they are shown as distinct components in FIG. 1, the functional components of the name-based communication system 20, including the gateway 40, the processing entity 48 and the web server 52, may be implemented by one or more computers. More particularly, in some embodiments, different ones of the gateway 40, the control entity 42, the content entity 44, the call establishment entity 50, and the web server 52 may be implemented by a single computer, in which case they are interconnected via one or more logical communication links. In other embodiments, different ones of the gateway 40, the control entity 42, the content entity 44, the call establishment entity 50, and the web server 52 may be implemented by a plurality of computers, in which case they are interconnected via one or more physical communication links. Similarly, although they are shown as distinct components in FIG. 1, in some embodiments, the database 31 and the database 35 may be part of a common database.

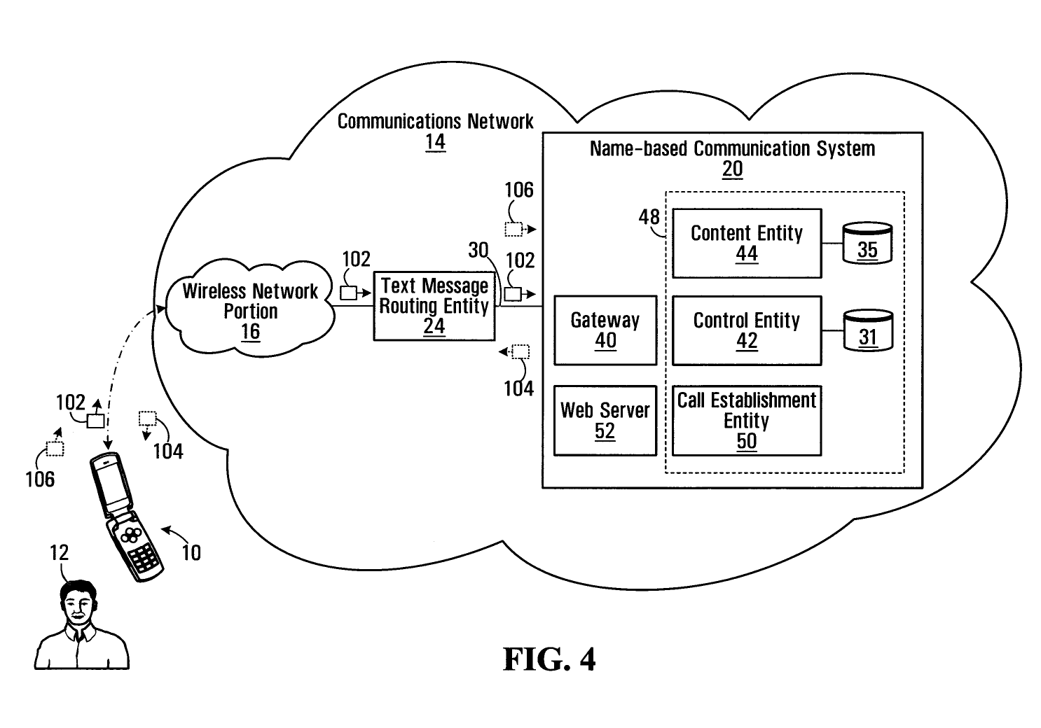

Turning now to FIG. 4, operation of the name-based communication system 20 will be illustrated in the context of an example where the user 12 uses the wireless communication device 10 to create and send to the name-based communication system 20 a message 102 conveying a name. For purposes of this example, it is assumed that the name, which is provided by the user 12 while interacting with the wireless communication device 10, is “j_smith”. It is further assumed that the message 102 is a text message (e.g., an SMS message) conveying the name “j_smith” and destined for the name-based communication system 20.

Thus, in this example, the user 12 interacts with an input device (e.g., a keypad) of the wireless communication device 10 to input the name “j_smith” to be conveyed by the text message 102 and to indicate that the text message's destination is the name-based communication system 20. The user 12 may indicate the text message's destination by entering a short code associated with the name-based communication system 20 (i.e., a “short” telephone number designating the name-based communication system 20 and having fewer digits than a normal length telephone number) into the wireless communication device 10. Alternatively, in some embodiments, the wireless communication device 10 may be designed to provide an option selectable by the user 12 using its input device to indicate that the text message's destination is the name-based communication system 20 without having to enter a short code (e.g., a selectable option such as “Send to <NBCS>”, where <NBCS> designates the name-based communication system 20). In response to a send command input by the user 12, the wireless communication device 10 sends the text message 102, which conveys the name “j_smith” entered by the user 12 and which indicates that its destination is the name-based communication system 20, over the wireless network portion 16 to a text message routing entity 24 (e.g., a Short Message Service Center (SMSC)).

Upon receiving the text message 102, the text message routing entity 24 recognizes that the text message 102 is destined for the name-based communication system 20 and proceeds to route the text message 102 to the name-based communication system 20 over a communication link 30. Along the communication link 30, one or more gateways (e.g., an SMS gateway) or other network elements may process (e.g., translate) the text message 102 in accordance with different messaging protocols (e.g., SMPP).

When the text message 102 reaches the name-based communication system 20, it is received and processed by the gateway 40. As mentioned previously, in some cases, the gateway 40 may process (e.g., translate) the text message 102 in accordance with a particular messaging protocol (e.g., a proprietary protocol) used by the name-based communication system 20.

The control entity 42 proceeds to determine whether the name “j_smith” conveyed by the text message 102 corresponds to a name registered in connection with the name-based communication service. To that end, the control entity 42 consults the database 31 in an attempt to identify a particular one of the records 33₁-33_{N} including a registered name that corresponds to the name “j_smith” conveyed by the text message 102.

If the control entity 42 is unable to identify a particular one of the records 33₁-33_{N} that corresponds to the name “j_smith” conveyed by the text message 102, the control entity 42 may send a text message 104 to the wireless communication device 10 via the gateway 40, the communication link 30, the text message routing entity 24 and the wireless network portion 16. The text message 104 indicates that the name “j_smith” does not correspond to a name registered in connection with the name-based communication service.

In some cases, the text message 104 may also provide an opportunity for the user 12 to register the name “j_smith” (entered by the user 12 and conveyed by the text message 102) in connection with the name-based communication service. For example, the text message 104 may convey an invitation to register the name “j_smith” (e.g., “Would you like to register j_smith for this service?”). The invitation may also indicate a fee associated with registration of the name “j_smith”. Upon reception of the text message 104 and display of the invitation to register the name “j_smith” by the wireless communication device 10, the user 12 may interact with the wireless communication device 10 in order to respond to (i.e., accept or decline) the invitation. For instance, the user 12 may enter a response (e.g., “yes” or “no”) via interaction with the input device of the wireless communication device 10, which may proceed to create and send over the wireless network portion 16 a text message 106 conveying the user's response and destined for the name-based communication system 20.

When the text message 106 is received by the name-based communication system 20, the control entity 42 proceeds to determine whether the response conveyed by the text message 106 is an acceptance or a declination of the user 12 to register the name “j_smith” conveyed by the text message 102. If the response is an acceptance, the control entity 42 registers the name “j_smith” and creates a record associated with that name in the database 31. The control entity 42 may also cause transmission of a text message (not shown) to the wireless communication device 10 to confirm registration of the name “j_smith” in connection with the name-based communication service. The control entity 42 may also interact with a billing entity (not shown) to cause billing of the user 12 for this registration. The name-based communication system 20 may then interact with the wireless communication device 10 to effect an exchange of messages therebetween to allow the user 12 to configure a profile associated with the name “j_smith”, which has been registered by the user 12. In configuring the profile, the user 12 may provide via the wireless communication device 10: contact information regarding the user 12; information specifying how to respond to a message which is received by the name-based communication system 20 and which conveys the name “j_smith”; and/or content information regarding the user 12, if any. Alternatively, the user 12 may (e.g., at a later time) use a computer to interact with the web site implemented by the web server 52 in order to configure the profile associated with the name “j_smith” registered by the user 12.

For purposes of this example, it is assumed that the name “j_smith” provided by the user 12 and conveyed by the text message 102 corresponds to a name registered in connection with the name-based communication service. It is further assumed that the name “j_smith” has been registered by an individual, say John Smith, known to the user 12. For instance, the user 12 may have entered the registered name “j_smith”, which is conveyed by the text message 102, in order to obtain information regarding John Smith and/or call or otherwise contact John Smith. As such, by consulting the database 31, the control entity 42 identifies a particular one of the records 33₁-33_{N} that includes the registered name “j_smith” corresponding to name conveyed by the text message 102.

Upon identifying the particular one of the records 33₁-33_{N} that corresponds to the registered name “j_smith”, the control entity 42 determines how to respond to the text message 102 based on the profile associated with the registered name “j_smith” and configured by John Smith. In this case, the control entity 42 determines which action(s) to perform based on information included in the particular one of the records 33₁-33_{N} associated with the registered name “j_smith”, namely the information derived from John Smith and specifying how to respond to a message (such as the text message 102) that is received by the name-based communication system 20 and that conveys the registered name “j_smith”.

More particularly, in this embodiment, the control entity 42 determines, based on the profile associated with the registered name “j_smith”, at least one action to perform from among a plurality of actions performable by the name-based communication system 20. For example, and as further described below: a first action performable by the name-based communication system 20 can be transmitting to the wireless communication device 10 information regarding John Smith and included in the profile (e.g., contact information and/or content information regarding John Smith); a second action performable by the name-based communication system 20 can be attempting to establish a phone call between the wireless communication device 10 and a given communication device associated with John Smith; and a third action performable by the name-based communication system 20 can be causing the wireless communication device 10 to present to the user 12 an invitation to contact John Smith without presenting to the user 12 contact information regarding John Smith.

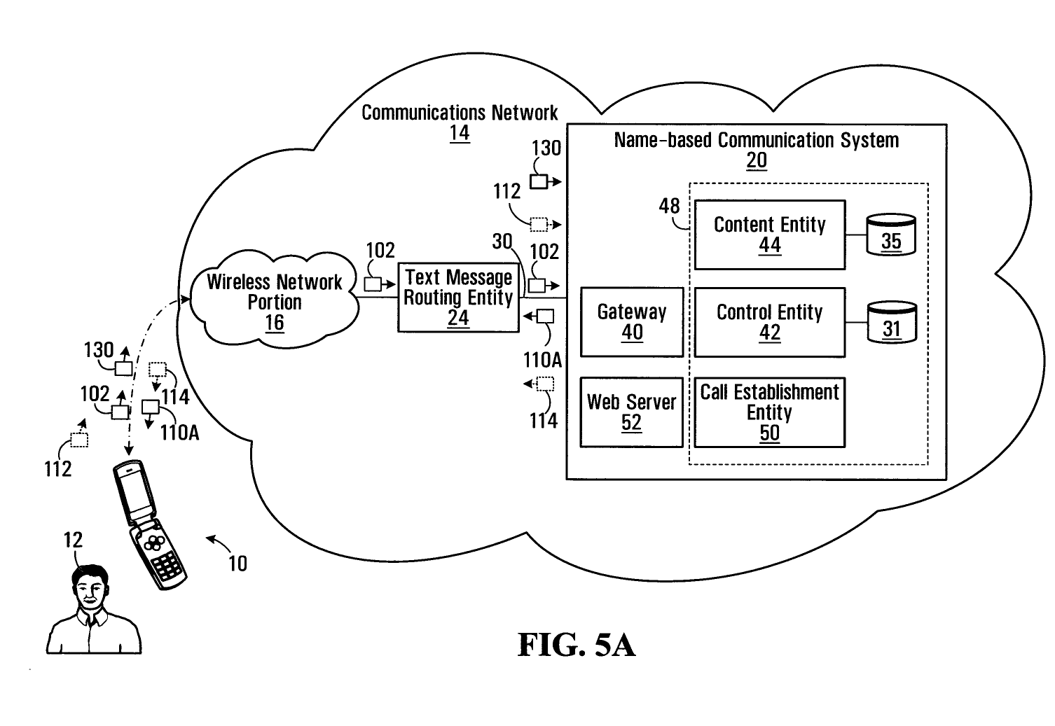

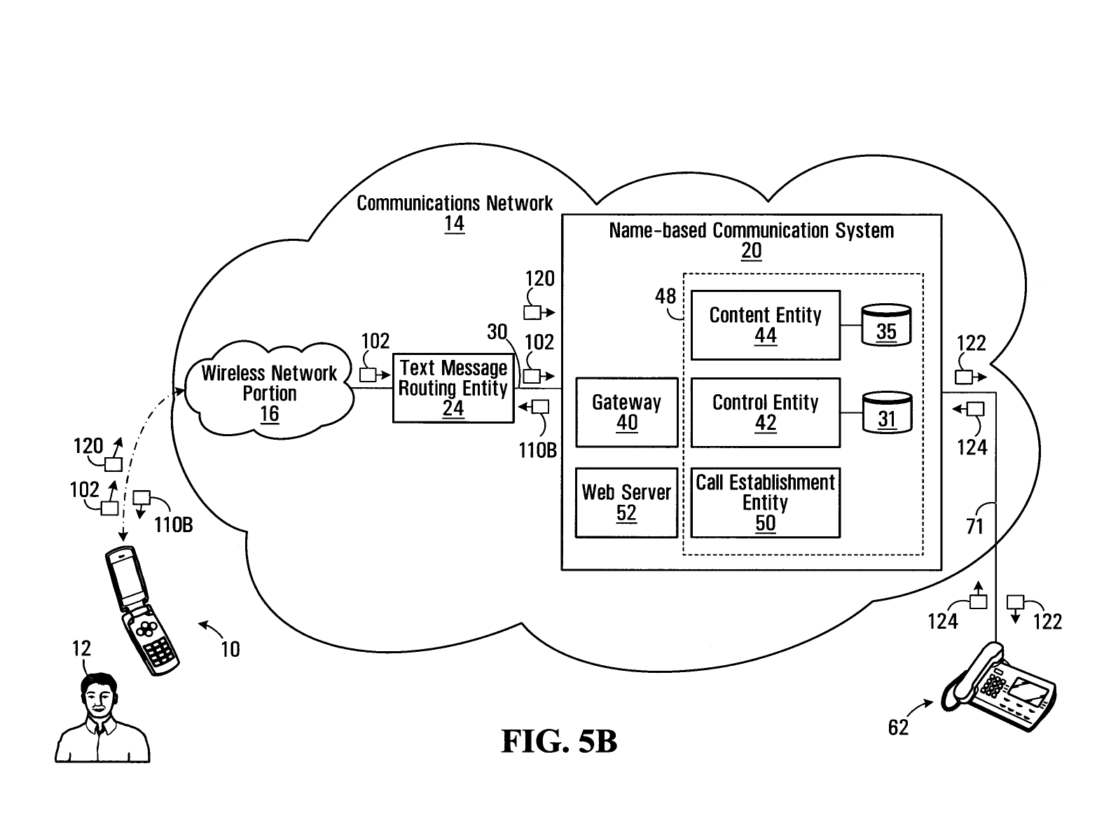

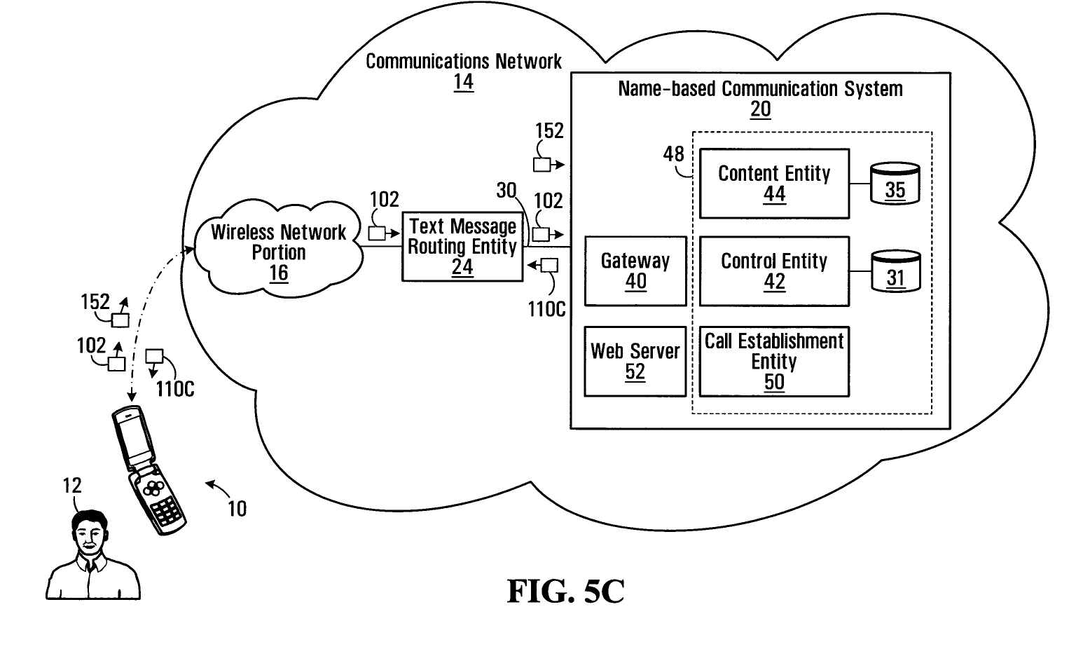

For instance, in a first example scenario, with reference to FIG. 5A, if the particular one of the records 33₁-33_{N} that corresponds to the registered name “j_smith” includes information specifying that, when the name-based communication system 20 receives from a given communication device (such as the wireless communication device 10) a message (such as the text message 102) conveying the registered name “j_smith”, part or all of the contact information regarding John Smith (included in the particular one of the records 33₁-33_{N}) and/or part or all of the content information regarding John Smith (accessible to the content entity 44), if any, is to be transmitted to the given communication device, the control entity 42 causes the processing entity 48 to generate a message 110A conveying this contact information and/or content information regarding John Smith. Depending on the contact information and/or content information regarding John Smith that it conveys, the message 110A may include a text message (e.g., an SMS message) or a multimedia message (e.g., an MMS message). The processing entity 48 sends the message 110A to the wireless communication device 10 based on an origin of the text message 102 (e.g., a telephone number of the wireless communication device 10), which is conveyed by the text message 102.

Upon receiving the message 110A, the wireless communication device 10 processes the message 110A so as to present to the user 12 the contact information and/or content information regarding John Smith that is conveyed by the message 110A. For example, in one case, the message 110A may convey a telephone number and an email address of John Smith as well as a picture of John Smith. In such a case, upon receiving the message 110A, the wireless communication device 10 displays on its display the telephone number, email and picture of John Smith for viewing by the user 12.

In some situations, the message 110A may indicate that one or more other portions of the contact information regarding John Smith and/or content information regarding John Smith that is included in the particular one of the records 33₁-33_{N} and/or the particular one of the records 37₁-37_{M} may be presented to the user 12. In these situations, upon processing the message 110A, the wireless communication device 10 indicates to the user 12 (e.g., via its display) that one or more other portions of the contact information and/or content information regarding John Smith are available. If he/she desires, the user 12 may interact with the wireless communication device 10 in order to request one or more other portions of the contact information and/or content information regarding John Smith. For example, upon interacting with the input device of the wireless communication device 10, the user 12 may cause the wireless communication device 10 to send a message 112 to the name-based communication system 20 via the wireless network portion 16, the message 112 requesting one or more other portions of the contact information and/or content information regarding John Smith. Upon receipt of the message 112 by the gateway 40, the processing entity 48 processes the message 112 and proceeds to generate and transmit to the wireless communication unit 10 a message 114 conveying the requested one or more other portions of the contact information and/or content information regarding John Smith. A similar exchange of messages may take place between the wireless communication unit 10 and the name-based communication system 20 in order to allow the user 12 to access various portions of the contact information and/or content information regarding John Smith that is part of the profile associated with the registered name “j_smith”.

Also, in cases where the message 110A conveys contact information regarding John Smith, the message 110A may cause the wireless communication device 10 to present this contact information along with one or more selectable options to contact John Smith on a basis of this contact information. For example, the message 110A may cause the wireless communication device 10 to display on its display one or more selectable options to contact John Smith (e.g., “Call j_smith at (555) 555-0001”,“Email j_smith at j.smith@enterprise123.com”, “Text message j_smith at (555) 555-0002”). The user 12 may then interact with the wireless communication device 10 to select an option of his/her choice.

For purposes of this first example scenario, it is assumed that the user 12 indeed interacts with the wireless communication device 10 to select an option of his/her choice. Upon selection by the user 12 of an option to contact John Smith, the wireless communication device 10 sends a text message 130 to the name-based communication system 20 over the wireless network portion 16, the text message 130 being indicative of the selected option to contact John Smith.

Upon receipt of the text message 130 by the gateway 40, the control entity 42 processes the text message 130 and determines the option to contact John Smith that has been selected by the user 12. The control entity 42 proceeds to act in accordance with the option selected by the user 12.

For example, if the user 12 selected an option to call John Smith, the control entity 42 causes the processing entity 48 to operate in a manner similar to that described below in respect of FIG. 5B in order to attempt to establish a phone call between the wireless communication device 10 and a given communication device associated with John Smith.

As another example, if the user 12 selected an option to email John Smith, the control entity 42 causes the processing entity 48 to exchange one or more messages (not shown) with the wireless communication device 10 so as to allow the user 12 to use the wireless communication device 10 to input textual information and/or non-textual information (e.g., a picture) to be sent via email to John Smith. Based on one or more messages received from the wireless communication device 10 conveying the textual information and/or non-textual information, the control entity 42 creates an email message to be sent to an email address of John Smith, which is obtained from the contact information included in the particular one of the records 33₁-33_{N} that corresponds to the registered name “j_smith”. The control entity 42 then proceeds to cause the processing entity 48 to send the email message over the communications network 14 in accordance with the email address of John Smith.

As yet another example, if the user 12 selected an option to contact John Smith via text messaging, the control entity 42 causes the processing entity 48 to exchange one or more messages (not shown) with the wireless communication device 10 so as to allow the user 12 to use the wireless communication device 10 to input textual information to be sent via text messaging to John Smith. Based on one or more messages received from the wireless communication device 10 conveying the textual information, the control entity 42 creates a text message to be sent to a given communication device associated with John Smith. Information identifying the given communication device associated with John Smith (e.g., a telephone number) is obtained from the contact information included in the particular one of the records 33₁-33_{N} that corresponds to the registered name “j_smith”. The control entity 42 then proceeds to cause the processing entity 48 to send the text message, which contains the textual information input by the user 12, to the given communication device associated with John Smith over the communications network 14.

Accordingly, in this first example scenario, the user 12 conveniently and easily obtained information regarding John Smith (i.e., contact information and/or content information regarding John Smith) simply by text messaging the registered name “j_smith” using the wireless communication device 10. The user 12 can also conveniently and easily contact John Smith (e.g., via phone, email or text message) by virtue of such text messaging. This may be particularly useful as it is typically easier for the user 12 to remember the registered name “j_smith” than remember John Smith's telephone number or other contact information. In fact, the user 12 does not even need to know John Smith's contact information in order to contact him.

In a second example scenario, with reference to FIG. 5B, if the particular one of the records 33₁-33_{N} that corresponds to the registered name “j_smith” includes information specifying that, when the name-based communication system 20 receives from a given communication device (such as the wireless communication device 10) a message (such as the text message 102) conveying the registered name “j_smith”, a phone call is to be established between the given communication device and a communication device 62 used, owned or otherwise associated with John Smith, the control entity 42 causes the processing entity 48 to generate at least one telephony message to attempt to establish a phone call between the wireless communication device 10 and the communication device 62 associated with John Smith.

More particularly, in this embodiment, the control entity 42 causes the call establishment entity 50 to generate and send a telephony message 110B to the wireless communication device 10 over the wireless network portion 16 in an attempt to establish a first call leg between the wireless communication device 10 and the call establishment entity 50. In other words, the telephony message 110B effectively calls the wireless communication device 10. The call establishment entity 50 generates and sends the telephony message 110B to the wireless communication device 10 based on an origin of the text message 102 (e.g., a telephone number of the wireless communication device 10), which is indicated by the text message 102.

In response to receipt of the telephony message 110B, the wireless communication device 10 rings, vibrates, and/or otherwise provides an indication of an incoming call. For purposes of this example, it is assumed that the user 12 answers the incoming call. This causes the wireless communication device 10 to send a telephony message 120 to the call establishment entity 50 to indicate that the incoming call has been answered. This also establishes a first call leg between the wireless communication device 10 and the call establishment entity 50.

Upon receiving the telephony message 120, the call establishment entity 50 determines that the first call leg has been established and proceeds to send a telephony message 122 to the communication device 62 associated with John Smith via a communication link 71 established over the communications network 14. The message 122 is transmitted to the communication device 62 based on information identifying the communication device 62 (e.g., a telephone number) and included in the contact information in the particular one of the records 33₁-33_{N} associated with the registered name “j_smith”.

In various example situations, the communication device 62 may be a plain old telephone service (POTS) phone (including a cordless phone), a wireless phone, a Voice-over-Internet Protocol (VoIP) phone, a POTS phone equipped with an analog terminal adapter (ATA), or a soft phone (i.e., a computer equipped with telephony software). Accordingly, depending on the nature of the communication device 62, the communication link 71 may span different network portions (e.g., a portion of the public switched telephony network (PSTN), a wireless network portion, and/or a data network portion) of the communications network 14 and traverse one or more network elements (e.g., a central office switch, a mobile switching center, or a softswitch) of the communications network 14.

In response to receipt of the telephony message 122, the communication device 62 rings, vibrates, and/or otherwise provides an indication of an incoming call. If the incoming call is not answered (e.g., since no one is around to answer the incoming call or no one proximate to the communication device 62 wants to answer the incoming call), the user 12 may hang up, thus terminating the first call leg between the wireless communication device 10 and the call establishment entity 50.

For purposes of this example scenario, it is assumed that someone, say John Smith himself, answers the incoming call at the communication device 62. This causes the communication device 62 to send a telephony message 124 to the call establishment entity 50 to indicate that the incoming call has been answered. This also establishes a second call leg between the communication device 62 and the call establishment entity 50.

Upon receiving the telephony message 124, the call establishment entity 50 determines that the second call leg has been established. The call establishment entity 50 proceeds to connect the first call leg (between the wireless communication device 10 and the call establishment entity 50) and the second call leg (between the communication device 62 and the call establishment entity 50) to establish a phone call between the wireless communication device 10 and the communication device 62. The user 12 and John Smith (who uses the communication device 62) may then have a conversation, which can be terminated in a conventional manner by the communications network 14.

Accordingly, in this second example scenario, the user 12 conveniently and easily called John Smith simply by text messaging the registered name “j_smith” using the wireless communication device 10. This may be particularly useful as it is typically easier for the user 12 to remember the registered name “j_smith” than remember John Smith's telephone number or other contact information. In fact, the user 12 does not even need to know John Smith's telephone number in order to call him.

In a third example scenario, with reference to FIG. 5C, if the particular one of the records 33₁-33_{N} that corresponds to the registered name “j_smith” includes information specifying that, when the name-based communication system 20 receives from a given communication device (such as the wireless communication device 10) a message (such as the text message 102) conveying the registered name “j_smith”, an invitation to call, email, text message or otherwise contact John Smith is to be presented to a user of the given communication device without providing John Smith's contact information to that user, the control entity 42 causes the processing entity 48 to generate a message 110C such that it causes the wireless communication device 10 to present to the user 12 an invitation to call, email, text message or otherwise contact John Smith without presenting to the user 12 John Smith's contact information. The processing entity 48 generates and sends the message 110C to the wireless communication device 10 based on an origin of the text message 102 (e.g., a telephone number of the wireless communication device 10), which is conveyed by the text message 102.

Upon receiving the message 110C, the wireless communication device 10 processes the message 110C so as to present to the user 12 the invitation to call, email, text message or otherwise contact John Smith without presenting to the user 12 John Smith's contact information. For example, the message 110C may cause the wireless communication device 10 to display on its display a list of selectable options to contact John Smith (e.g., “Call j_smith”, “Email j_smith”, “Text message j_smith”), without displaying John Smith's contact information. The user 12 may then interact with the wireless communication device 10 to select an option of his/her choice.

For purposes of this example, it is assumed that the user 12 indeed interacts with the wireless communication device 10 to select an option of his/her choice. Upon selection by the user 12 of an option to contact John Smith, the wireless communication device 10 sends a text message 152 to the name-based communication system 20 over the wireless network portion 16, the text message 152 being indicative of the selected option to contact John Smith.

Upon receipt of the text message 152 by the gateway 40, the control entity 42 processes the text message 152 and determines the option to contact John Smith that has been selected by the user 12. The control entity 42 proceeds to act in accordance with the option selected by the user 12.

For example, if the user 12 selected an option to call John Smith, the control entity 42 causes the processing entity 48 to operate in a manner similar to that described above in respect of FIG. 5B in order to attempt to establish a phone call between the wireless communication device 10 and the communication device 62 associated with John Smith.

As another example, if the user 12 selected an option to email John Smith, the control entity 42 causes the processing entity 48 to exchange one or more messages (not shown) with the wireless communication device 10 so as to allow the user 12 to use the wireless communication device 10 to input textual information and/or non-textual information (e.g., a picture) to be sent via email to John Smith. Based on one or more messages received from the wireless communication device 10 conveying the textual information and/or non-textual information, the control entity 42 creates an email message to be sent to an email address of John Smith, which is obtained from the contact information included in the particular one of the records 33₁-33_{N} that corresponds to the registered name “j_smith”. The control entity 42 then proceeds to cause the processing entity 48 to send the email message over the communications network 14 in accordance with the email address of John Smith.

As yet another example, if the user 12 selected an option to contact John Smith via text messaging, the control entity 42 causes the processing entity 48 to exchange one or more messages (not shown) with the wireless communication device 10 so as to allow the user 12 to use the wireless communication device 10 to input textual information to be sent via text messaging to John Smith. Based on one or more messages received from the wireless communication device 10 conveying the textual information, the control entity 42 creates a text message to be sent to a given communication device associated with John Smith (e.g., the communication device 62). Information identifying the given communication device associated with John

Smith (e.g., a telephone number) is obtained from the contact information included in the particular one of the records 33₁-33_{N} that corresponds to the registered name “j_smith”. The control entity 42 then proceeds to cause the processing entity 48 to send the text message, which contains the textual information input by the user 12, to the given communication device associated with John Smith over the communications network 14.

Accordingly, in this third example scenario, the user 12 conveniently and easily contacted John Smith (e.g., via phone, email or text message) simply by text messaging the registered name “j_smith” using the wireless communication device 10. This may be particularly useful as it is typically easier for the user 12 to remember the registered name “j_smith” than remember John Smith's telephone number or other contact information. In fact, the user 12 does not even need to know John Smith's contact information in order to contact him. Moreover, since the invitation conveyed by the message 110C to call, email, text message or otherwise contact John Smith does not result in the user 12 being presented with John Smith's contact information, the name-based communication service allows John Smith to keep his contact information private.

It will thus be appreciated that the name-based communication system 20 enables the user 12 to obtain information regarding John Smith (i.e., contact information and/or content information regarding John Smith) and/or contact John Smith (e.g., by phone, email or text message) simply by text messaging the registered name “j_smith” using the wireless communication device 10. As such, the user 12 need not remember or even know John Smith's telephone number or other contact information in order to obtain information regarding John Smith or contact him.

It will also be appreciated that, while the above-considered example relates to a case where the user 12 provides via the wireless communication device 10 a registered name (in this case, “j_smith”) that has been registered by an individual (in this case, John Smith), in other cases, the user 12 may provide via the wireless communication device 10 a registered name that has been registered by a particular organization (e.g., an enterprise, a government agency, etc.). In such cases, the wireless communication device 10 creates and sends to the name-based communication system 20 a text message (such as the text message 102) which conveys the registered name registered by the particular organization in order to obtain information regarding the particular organization (i.e., contact information and/or content information regarding the particular organization) and/or contact the particular organization (e.g., by phone, email or text message), as described above.

For example, where the user 12 provides via the wireless communication device 10 the registered name “companyABC”, which has been registered by an enterprise called Company ABC, the user 12 may obtain on the wireless communication device 10: one or more telephone numbers or email addresses of Company ABC (e.g., main, sales, technical support, etc.); one or more street addresses of one or more locations (e.g., stores) of Company ABC; a map of or driving directions to such a location; information about one or more products or services offered by Company ABC (e.g., a list of offered products or services, advertising information, etc.); etc. The user 12 may also use the wireless communication device 10 to contact Company ABC (e.g., by phone or email) based on messages exchanged between the wireless communication device 10 and the name-based communication system 20, as described above.

As another example, the user 12 may provide via the wireless communication device 10 a more elaborate registered name that has been registered by Company ABC, in order to obtain more specific information regarding Company ABC or contact a specific employee or department of Company ABC. For instance: where the user 12 provides via the wireless communication device 10 the registered name “techsupport*companyABC”, which has been registered by Company ABC, the user 12 may obtain on the wireless communication device 10 a telephone number or email address of a technical support department of Company ABC, troubleshooting information about one or more products or services offered by Company ABC, etc.; where the user 12 provides via the wireless communication device 10 the registered name “products*companyABC”, which has been registered by Company ABC, the user 12 may obtain on the wireless communication device 10 a list of offered products, promotions, etc.; and so on.

The name-based communication system 20 thus provides an efficient and convenient way for an organization to deliver relevant information about itself to actual or potential clients (such as the user 12) and/or to allow such clients to contact it.

It will further be appreciated that various modifications and enhancements to the name-based communication system 20 may be made in other embodiments. For example, in some embodiments, the name-based communication system 20 may comprise an ad server operative to deliver one or more advertisements to the wireless communication device 10 along with contact information and/or content information regarding a given party having registered a particular registered name that is conveyed by a message (such as the message 102) transmitted by the wireless communication device 10 to the name-based communication system 20. The ad server may determine which advertisement to present to the user 12 from a plurality of available advertisements on a basis of the particular registered name entered by the user 12. For instance, a top-level name portion and one or more sub-level name portions of the particular registered name input by the user 12 may constitute keywords that are processed by the ad server in order to determine an advertisement to be presented to the user 12.

Although in embodiments considered above certain messages exchanged between the wireless communication device 10 and the name-based communication system 20 are text messages or multimedia messages, it is to be understood that, in other embodiments, other types of messages may be exchanged between the wireless communication device 10 and the name-based communication system 20. For example, messages exchanged between the wireless communication device 10 and the name-based communication system 20 may be based on various wireless communication protocols (e.g., wireless application protocol (WAP)).

Also, although it is shown as a single element in embodiments considered above in connection with FIGS. 4 and 5A to 5C, each message transmitted or received by the name-based communication system 20 or the wireless communication device 10 (e.g., the message 102, 110A, 110B, 110C, 112, 114, 120, 122, 124, 130 or 152) may in some cases comprise a series of messages that collectively constitute that message.

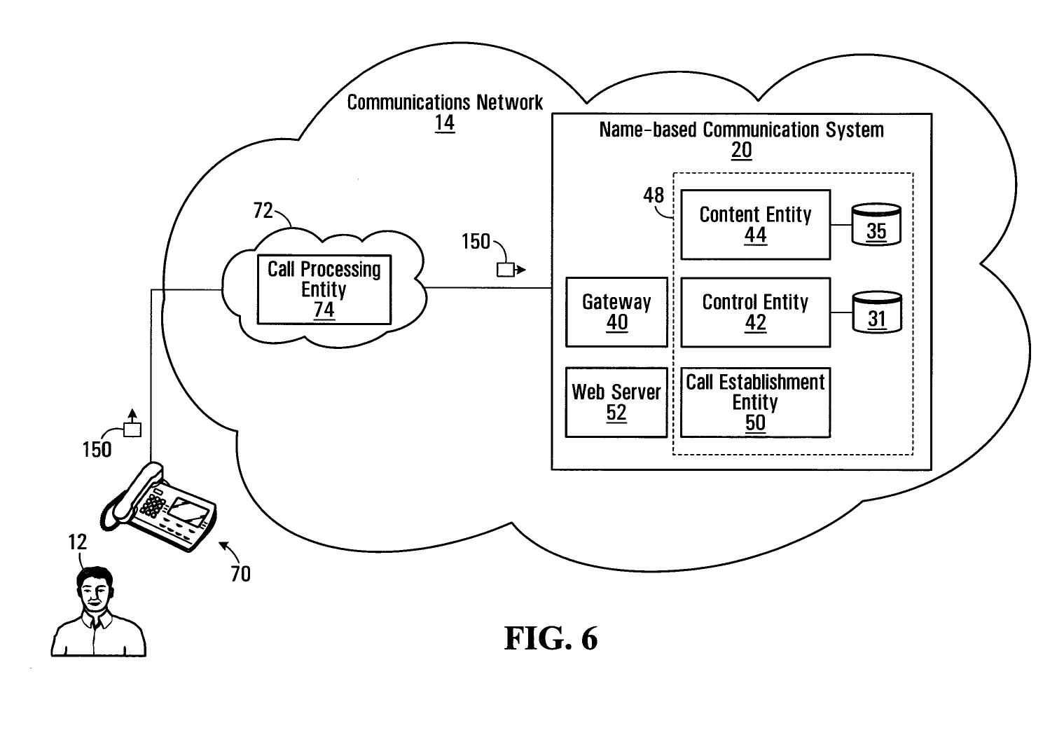

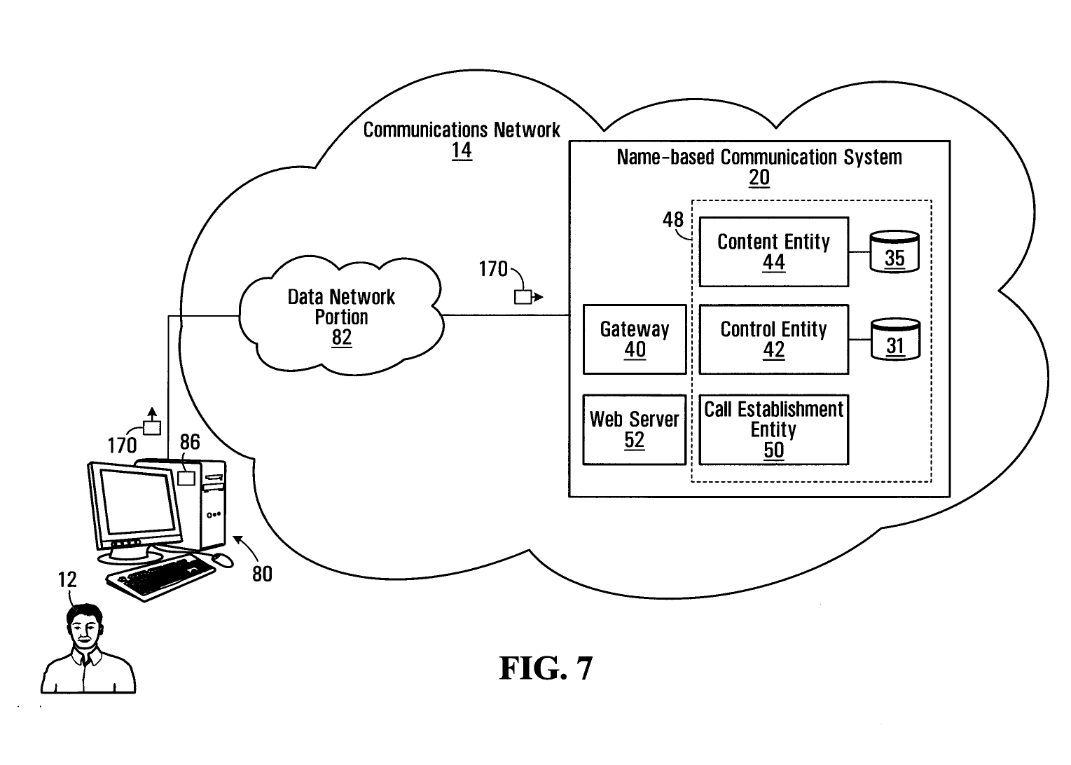

In addition, while in embodiments considered above the user 12 uses the wireless communication device 10 to interact with the name-based communication system 20 as part of the name-based communication service, in other embodiments, the user 12 may use other types of communication devices to avail himself/herself of this service. For example, FIGS. 6 and 7 illustrate embodiments in which the user 12 may use another communication device that is connected to the communications network 14 in order to interact with the name-based communication system 20 as part of the name-based communication service.

More particularly, FIG. 6 illustrates an embodiment in which the user 12 may use a wired phone 70 to interact with the name-based communication system 20 as part of the name-based communication service. For example, the wired phone 70 may be a POTS phone (including a cordless phone), a VoIP phone, a POTS phone equipped with ATA, or a soft phone. The wired phone 70 is connected to a network portion 72 of the communications network 14 (e.g., a portion of the PSTN and/or a data network portion). The network portion 72 comprises a call processing entity 74 operative to effect call control operations to help route an outgoing call originated at the wired phone 70 and help route an incoming call destined for the wired phone 70. For example, depending on the nature of the wired phone 70, the call processing entity 72 may be part of a central office switch or a softswitch. The name-based communication system 20 is operative to exchange messages with the wired phone 70 over the network portion 72. For instance, the gateway 40 (or another component) of the name-based communication system 20 may be adapted to exchange messages over the network portion 72.

In this embodiment, and based on principles similar to those discussed above, the user 12 may use the wired phone 70 to send a message 150 conveying a particular registered name to the name-based communication system 20 in order to obtain information (e.g., contact information and/or content information) regarding a given party having registered the particular registered name and/or call or otherwise contact the given party. For example, the user 12 may use the wired phone 70 to call a telephone number associated with the name-based communication system 20, thereby causing the call processing entity 74 to establish a call between the wired phone 70 and the control entity 42 of the name-based communication system 20 over the network portion 72. The user 12 may then cause the wired phone 70 to transmit the message 150 conveying the particular registered name to the name-based communication system 20. For instance, the user 12 may enter the particular registered name by interacting with a keypad of the wired phone 70. Alternatively, the user 12 may speak the particular registered name, in which case the control entity 42 processes the message 150 (conveying the particular registered name spoken by the user 12) using a speech-to-text module in order to obtain the particular registered name.

Upon obtaining the particular registered name by processing the message 150, the control entity 42 attempts to identify a particular one of the records 33₁-33_{N} that corresponds to the particular registered name provided by the user 12.

Assuming that it identifies a particular one of the records 33₁-33_{N} that corresponds to the particular registered name conveyed by the message 150, the control entity 42 determines how to respond to the message 150 based on the profile associated with the particular registered name and configured by the given party that registered the particular registered name. More particularly, in this embodiment, the control entity 42 determines, based on the profile associated with the particular registered name, at least one action to perform from among a plurality of actions performable by the name-based communication system 20. In this case: a first action performable by the name-based communication system 20 can be transmitting to the wired phone 70 part or all of the contact information regarding the given party (included in the particular one of the records 33₁-33_{N}) and/or part or all of the content information regarding the given party (accessible to the content entity 44), if any; and a second action performable by the name-based communication system 20 can be attempting to establish a phone call between the wired phone 70 and a communication device associated with the given party.

Upon making this determination, the control entity 42 causes the processing entity 48 to perform the at least one action. For example, if an action to be performed is transmitting to the wired phone 70 contact information and/or content information regarding the given party, the control entity 42 causes the processing entity 48 to generate and send to the wired phone 70 a message (not shown) conveying this information. The message may be generated by the processing entity 48 using a text-to-speech module so that the contact information and/or content information regarding the given party can be verbally conveyed to the user 12 via the wired phone 70. Alternatively, if an action to the performed is attempting to establish a phone call between the wired phone 70 and a communication device associated with the given party, the control entity 42 causes the call establishment entity 50 to generate and send to the communication device associated with the given party a telephony message in order to establish the phone call in question. In this case, the call establishment entity 50 may not need to transmit a telephony message to the wired phone 70 in view of the call already established between the wired phone 70 and the name-based communication system 20 over the network portion 72. In response to receipt of the telephony message, the communication device associated with the given party rings, vibrates, and/or otherwise provides an indication of an incoming call. Assuming that someone answers the incoming call, the communication device associated with the given party sends a telephony message to the call establishment entity 50 to indicate that the incoming call has been answered. This establishes a call leg between the communication device associated with the given party and the call establishment entity 50. Upon receiving the telephony message transmitted by the communication device associated with the given party, the call establishment entity 50 proceeds to connect the call established between the wired phone 70 and the call establishment entity 50 and the call leg between the communication device associated with the given party and the call establishment entity 50, thus establishing a phone call between the wired phone 70 and the communication device associated with the given party.

FIG. 7 illustrates an embodiment in which the user 12 may use a computing apparatus 80 to interact with the name-based communication system 20 as part of the name-based communication service. For example, the computing apparatus 80 may comprise a personal computer such as a desktop or laptop computer. The computing apparatus 80 is connected to a data network portion 82 of the communications network 14 (e.g., the Internet). The computing apparatus 80 is operative to run a web browser application with which the user 12 can interact via a display (and possibly one or more other output devices) of the computing apparatus 80 and at least one input device (e.g., a mouse, keyboard, etc.) in order to access and interact with network sites (e.g., web sites) of the data network portion 82.

In this embodiment, the computing apparatus 80 implements a software application 86 that interacts with the web browser application in order to enable the computing apparatus 80 to exchange messages with the name-based communication system 20 over the data network portion 82. For example, the software application 86 may be a plug-in downloaded to the computing apparatus 80 via the data network portion 82 as a result of the user 12 using the computing apparatus 80 to access and interact with the web site implemented by the web server 52 of the name-based communication system 20.

The software application 86 enables the user 12 to input a particular registered name registered in connection with the name-based communication service in order to obtain contact information and/or content information regarding a given party having registered the particular registered name. For example, the software application 86 may provide a widget (e.g., a field) in a graphical user interface (GUI) implemented by the web browser application to allow the user 12 to enter the particular registered name. The widget is independent of an address bar of the GUI implemented by the web browser application. For instance, the widget may provide a field separate from the address bar of the GUI implemented by the web browser application.

Upon inputting the particular registered name using the widget provided by the software application 86, the software application 86 creates a message 170 that is sent to the name-based communication system 20 over the data network portion 82. The message 170 conveys the particular registered name input by the user 12.

In various embodiments, and depending on a configuration of the name-based communication system 20 and functionality of the gateway 40 and the web server 52, the message 170 may be received and processed by the gateway 40 or the web server 52. The control entity 42 then proceeds to obtain the particular registered name conveyed by the message 170 and attempts to identify a particular one of the records 33₁-33_{N} that corresponds to this particular registered name.

Assuming that it identifies a particular one of the records 33₁-33_{N} that corresponds to the particular registered name conveyed by the message 170, the control entity 42 determines how to respond to the message 170 based on the profile associated with the particular registered name and configured by the given party having registered the particular registered name. In this embodiment, the control entity 42 determines that an action to perform is transmitting to the computing apparatus 80 part or all of the contact information regarding the given party (included in the particular one of the records 33₁-33_{N}) and/or part or all of the content information regarding the given party (accessible to the content entity 44), if any.

Upon making this determination, the control entity 42 causes the processing entity 48 to generate a message (not shown) conveying the contact information and/or content information regarding the given party. In various embodiments, the message may be transmitted by the gateway 40 or the web server 52 to the computing apparatus 80 over the data network portion 82. Upon receiving the message, the computing apparatus 80 processes it in order to present to the user 12 the contact information and/or content information regarding the given party.

While in the above-considered embodiment interaction between the computing apparatus 80 and the name-based communication system 20 is enabled by the software application 86 implemented by the computing apparatus 80, in other embodiments, the computing apparatus 80 and its web browser application may exchange messages with the name-based communication system 20 over the data network portion 82 without requiring the software application 86. For instance, in some embodiments, the user 12 may use the computing apparatus 80 to access and interact with the web site implemented by the web server 52 of the name-based communication system 20 in order to enter via the web site a particular registered name so as to obtain contact information and/or content information regarding a given party having registered the particular registered name.

Although various embodiments of the present invention have been described and illustrated, it will be apparent to those skilled in the art that numerous modifications and variations can be made without departing from the scope of the invention, which is defined in the appended claims.

1. A method for execution by a communication system, said method comprising:
receiving from a first communication device a name registered in connection with a communication service and provided by a user of the first communication device;
identifying a profile associated with the name and configured by a party having registered the name;
determining, based on the profile, at least one action to perform from among a plurality of actions performable by the communication system, the plurality of actions including:
transmitting to the first communication device information regarding the party and included in the profile; and
attempting to establish a phone call between the first communication device and a second communication device associated with the party; and
performing the at least one action.

2. The method as claimed in claim 1, wherein the first communication device is a wireless communication device.

3. The method as claimed in claim 2, wherein said receiving comprises receiving from the wireless communication device a text message conveying the name.

4. The method as claimed in claim 2, wherein said transmitting comprises transmitting to the wireless communication device at least one message conveying the information regarding the party and included in the profile, the at least one message including at least one of a text message and a multimedia message.

5. The method as claimed in claim 1, wherein the information regarding the party and included in the profile includes at least one of contact information regarding the party and content information regarding the party.

6. The method as claimed in claim 1, wherein said attempting comprises transmitting at least one telephony message to attempt establishing the phone call.

7. The method as claimed in claim 6, wherein the at least one telephony message includes a first telephony message transmitted to the first communication device to establish a first call leg and a second telephony message transmitted to the second communication device to establish a second call leg, the first call leg being connectable to the second call leg to establish the phone call.

8. The method as claimed in claim 1, wherein the plurality of actions includes causing the first communication device to present to the user an invitation to contact the party without presenting to the user contact information regarding the party.

9. The method as claimed in claim 1, comprising:
receiving from the first communication device an indication of the user desiring to call the party; and
attempting to establish a phone call between the first communication device and the second communication device.

10. The method as claimed in claim 1, comprising:
receiving from the first communication device an indication of the user desiring to email the party;
creating an email message based on information provided by the user via the first communication device; and
sending the email message in accordance with an email address associated with the party.

11. The method as claimed in claim 1, comprising:
receiving from the first communication device an indication of the user desiring to text message the party;
creating a text message based on information provided by the user via the first communication device; and
sending the text message in accordance with a telephone number associated with the party.

12. The method as claimed in claim 1, wherein the communication service allows registration of names having a top-level name portion and one or more sub-level name portions.

13. A system for providing a communication service, said system comprising:
an input for receiving from a first communication device a name registered in connection with the communication service and provided by a user of the first communication device; and
a processing entity for:
identifying a profile associated with the name and configured by a party having registered the name;
determining, based on the profile, at least one action to perform from among a plurality of actions performable by said system, the plurality of actions including:
transmitting to the first communication device information regarding the party and included in the profile; and
attempting to establish a phone call between the first communication device and a second communication device associated with the party; and
performing the at least one action.

14. The system as claimed in claim 13, wherein the first communication device comprises a wireless communication device.

15. The system as claimed in claim 14, wherein said input is operative for receiving from the wireless communication device a text message conveying the name.

16. The system as claimed in claim 14, wherein said transmitting comprises transmitting to the wireless communication device at least one message conveying the information regarding the party and included in the profile, the at least one message including at least one of a text message and a multimedia message.

17. The system as claimed in claim 13, wherein the information regarding the party and included in the profile includes at least one of contact information regarding the party and content information regarding the party.

18. The system as claimed in claim 13, wherein said attempting comprises transmitting at least one telephony message to attempt establishing the phone call.

19. The system as claimed in claim 18, wherein the at least one telephony message includes a first telephony message transmitted to the first communication device to establish a first call leg and a second telephony message transmitted to the second communication device to establish a second call leg, the first call leg being connectable to the second call leg to establish the phone call.

20. The system as claimed in claim 13, wherein the plurality of actions includes causing the first communication device to present to the user an invitation to contact the party without presenting to the user contact information regarding the party.

21. The system as claimed in claim 13, wherein said input is operative for receiving from the first communication device an indication of the user desiring to call the party, and said processing entity is responsive to receipt of an indication of the user desiring to call the party for attempting to establish a phone call between the first communication device and the second communication device.

22. The system as claimed in claim 13, wherein said input is operative for receiving from the first communication device an indication of the user desiring to email the party, and said processing entity is responsive to receipt of an indication of the user desiring to email the party for:
creating an email message based on information provided by the user via the first communication device; and
sending the email message in accordance with an email address associated with the party.

23. The system as claimed in claim 13, wherein said input is operative for receiving from the first communication device an indication of the user desiring to text message the party, and said processing entity is responsive to receipt of an indication of the user desiring to text message the party for:
creating a text message based on information provided by the user via the first communication device; and
sending the text message in accordance with a telephone number associated with the party.

24. The system as claimed in claim 13, wherein the communication, service allows registration of names having a top-level name portion and one or more sub-level name portions.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. A server for facilitating registration of names in connection with a communication service, said server comprising:
a data network interface for exchanging data with a computing apparatus over a data network; and
a processing unit for implementing a web site, said web site enabling a user of the computing apparatus to register a name in connection with the communication service, said web site enabling the user of the computing apparatus to configure a profile associated with the name such that the profile indicates which of a plurality of actions is to be performed in response to a message conveying the name and transmitted by a first communication device, the plurality of actions including:
transmitting to the first communication device information included in the profile; and
attempting to establish a phone call between the first communication device and a second communication device.

50. A wireless communication device comprising:
an input device for interacting with a user;
a wireless network interface for exchanging messages over a wireless network; and
a processing unit coupled to said input device and said wireless network interface, said processing unit being operative for:
receiving a name provided by the user via said input device;
generating a text message conveying the name and destined for a communication system, without requiring the user to provide a short code associated with the communication system via the input device; and
releasing the text message via said wireless network interface.
